(19) United States
(12) Patent Application Publication
(10) Pub. No.: US 2003/0214475 A1
(43) Pub. Date: Nov. 20, 2003

(54) Display medium

(75) Inventors: Yoshihiro Izumi, Kashihara-shi (JP); Masahiro Shimizu, Yamatokoriyama-shi (JP)

Correspondence Address: Keating & Bennett LLP, Suite 312, 10400 Eaton Place, Fairfax, VA, 22030, US

(73) Assignee: Sharp Kabushiki Kaisha, Osaka (JP)

(21) Appl. No.: 10/436,978

(22) Filed: May 14, 2003

(30) Foreign Application Priority Data
May 17, 2002 (JP) 2002-143159

(51) Int. Cl. G09G 3/36

(52) U.S. Cl. 345/87

(57) ABSTRACT

A display medium includes a sheet having a first main surface and a second main surface opposite to each other, a first area where information is statically displayed, and a second area where information is dynamically displayed. A static display medium is located in the first area of the sheet and a dynamic display medium is located in the second area of the sheet. The static display medium and the dynamic display medium are integrated in the sheet and form a portion of the sheet, and are preferably substantially flush with one of the first main surface and the second main surface of the sheet. The static display medium and the dynamic display medium share at least one common element including one of a conductive ink, a black matrix and a color filter.

### BACKGROUND OF THE INVENTION

1. Field of the Invention

The present invention relates to a display medium (information display medium) including a combination of a static display area for statically displaying information, for example, represented by conventional printed matter, and a dynamic display area for dynamically displaying moving images or pictures, for example.

2. Description of the Related Art

Conventional display media can be classified as either a static display medium or a dynamic display medium. More specifically, static display media, such as printed matter, have formed thereon and display information such as alphanumeric characters and pictures that are static and cannot be changed and cannot depict moving images or pictures. In contrast, dynamic display media, such as a conventional LCD, for example, are capable of displaying changeable and movable images as pictures such as a series of slides or pictures, or video images, etc.

A display element that may be called “electronic paper” is being developed in order to replace printed matter (including newspapers, magazines, and books, and other printed matter that is sometimes referred to as “hard copies”) that statically display information on paper and have been formed of ink.

Various forms of electronic paper are described, for example, in “Can Electronic Paper Replace Paper?”, Nikkei Science, February 2002 (on the market on Dec. 25, 2001), pp. 42 to 51 (original: The Electronic Paper Chase, Scientific American, November 2001, Steve Ditlea). Electronic paper is also defined as an element having a small thickness which can be used as an alternative medium to paper, while also having flexibility and a display memory function.

In the present specification, the medium represented by paper is herein referred to as a static display medium or a medium that statically displays information as mentioned above. The electronic paper mentioned above is a dynamic display medium in that it enables rewriting or changing of information to be displayed thereon, as mentioned above. The dynamic display medium is not limited to the display of moving pictures. Further, the dynamic display medium does not necessarily need to have flexibility or a display memory function as does the electronic paper in the narrow sense described above. The term “dynamic display medium” as used herein can be considered to be a thin member disposed inside of a display element (for example, the thickness is 5 mm or less). Examples of the dynamic display medium include a liquid display element, an EL display element, and an electrophoresis display element (including an in-plane type, twist ball type, and an electrophoresis microcapsule ink type).

Advantages of using the dynamic display medium are that it allows rewriting or changing of information thereby saving resources (use as soft copy) and that it can display desired information at a desired time via an information network (use as a display section of a portable information terminal). Another major advantage is that it can display moving pictures depending on the display method of the dynamic display medium.

Many dynamic display media being developed are relatively small (typically, their display areas are equal to or smaller than an A5 size). The main purpose of such a small size is to make the dynamic display medium portable. As a result, when the dynamic display medium is utilized as, for example, an electronic newspaper, an operation such as scrolling of a screen is required because the medium can display only a small amount of information at a given time.

On the other hand, static display media, for example, newspapers, have relatively large display surfaces. The static display medium thus has the advantage of allowing a large amount of information to be displayed in one display surface. Accordingly, a reader (user) can observe or scan a large amount of information within one particular view and can quickly obtain required detailed information by moving the reader's eyes or point of view so as to scan all of the large display surface (this feature may be called a “scanning function”). For example, the reader can choose to scan the entire large display area to view only the headlines of articles and can decide to read in detail only articles in which the reader is interested.

Although development is ongoing for dynamic display media that can replace paper, such as a display element with flexibility, no dynamic display media have been successfully developed which can replace newspapers. For example, the display medium is required to have an improved display grade (readability), an increased display area, and improved portability.

Further, even if a dynamic display medium that can replace a newspaper is successfully developed, it is expected that the static display medium using paper is not discarded because of its additional features such as its low cost and smooth touch.

### SUMMARY OF THE INVENTION

In order to overcome the problems described above, preferred embodiments of the present invention provide a display medium having the advantages of both a static display medium and dynamic display medium.

According to a preferred embodiment of the present invention, a display medium includes a sheet having a first main surface and a second main surface opposite to each other, a first area where information is statically displayed, and

a second area where information is dynamically displayed.

The term “information” as used in the description of preferred embodiments of the present invention means information that is a representation or expression of an idea, concept, story, etc., which is not merely an indicia or indication of the function of a button on the display, such as the keys on an electronic device such as a Personal Digital Assistant (PDA) or calculator having a dynamic display.

It is preferable that the statically displayed information and the dynamically displayed information are displayed on the first main surface of the sheet. Alternatively, the statically displayed information and the dynamically displayed information each can be displayed on one or both of the first main surface and the second main surface of the sheet.

A static display medium is preferably located in the first area and a dynamic display medium is preferably located in the second area. The static display medium and the dynamic display medium are preferably substantially flush with one of the first main surface and the second main surface of the sheet.

It is also preferred that the static display medium and the dynamic display medium share at least one common element including one of a conductive ink, a black matrix and a color filter.

Each of the static display medium and the dynamic display medium is preferably integrated in the sheet and forms a portion of the sheet. That is, the dynamic display medium preferably includes an element or member formed of the same material as that used to display the information that is statically displayed.

The dynamic display medium may be a reflection type display medium utilizing the sheet as a reflection layer, an active matrix display element, a flexible display element, includes a transferred active element that is independently formed and transferred to the sheet, a liquid crystal display medium (PDLC, FLC, AFLC, or other suitable display medium) or an electrophoretic display medium which has a memory function.

The dynamic display medium may include a plurality of conductive members formed of conductive ink that is also used to statically display information in the first area.

The dynamic display medium may also include a plurality of pixels, and a light blocking layer that prevents light from passing between the plurality of pixels is made of ink used to statically display information in the first area. The ink may be of one color or of a plurality of colors and may form color filters for the pixels.

The dynamic display medium may also include a plurality of conductive members and at least one of a power supply circuit, a driving circuit, and a storage circuit in an area of the sheet that is different from the first area, and the at least one circuit and some of the plurality of conductive members included in the dynamic display medium are electrically connected together via wiring made of the conductive ink, which is also used to statically display information in the first area.

The sheet may be made of paper or plastic, or may also be made of metal or ceramic of other suitable material. The sheet is preferably flexible and may include a base material and a protective layer provided in at least a second area of the base material. The base material of the sheet may be fibrous.

The display medium may also include a plurality of the sheets on which information is statically displayed in the first area of the main surface of the sheets.

In another preferred embodiment, a material which is used to display information in the first area is decolorable so as to change into a decolored state in response to a chemical reaction.

According to another preferred embodiment of the present invention, a display includes a sheet having a first main surface, information being statically displayed in a first area of the first main surface, and a dynamic display medium, which dynamically displays information, provided on a second main surface of the sheet opposite to the first main surface such that the dynamically displayed information is observed through a second area of the first main surface.

Furthermore, according to yet another preferred embodiment of the present invention, a method of forming a display medium includes the steps of providing a sheet having a first main surface and a second main surface opposite to each other, forming statically displayed information in a first area, and forming dynamically displayed information in a second area.

In this preferred embodiment, a material which is used to form the statically displayed information in the first area is preferably decolorable, and the method further includes the step of applying a material to the statically displayed information in the first area so as to change the decolorable material into a decolored state in response to a chemical reaction, and forming new statically displayed information in the first area.

This method also preferably includes the steps of forming a dynamic display medium separate from the sheet and transferring the dynamic display medium to the sheet.

It is also preferred to form a static display medium in the first area and forming a dynamic display medium in the second area such that the static display medium and the dynamic display medium are substantially flush with one of the first main surface and the second main surface of the sheet.

The static display medium and the dynamic display medium preferably share at least one common element including one of a conductive ink, a black matrix and a color filter.

It is also preferred that each of the static display medium and the dynamic display medium is integrated in the sheet and forms a portion of the sheet.

According to a further preferred embodiment of the present invention, a method of distributing information includes the steps of providing a display medium a static display portion having statically displaying information in a first area and a dynamic display portion dynamically displaying information in a second area, removing the dynamic display portion from the display medium, and updating information in the dynamic display portion, and attaching the dynamic display portion to another display medium including different statically displayed information.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1 is a perspective view schematically showing a configuration of a display medium according to a preferred embodiment of the present invention.

FIG. 2 is a schematic view showing a configuration of a display medium according to a preferred embodiment of the present invention.

FIG. 3 is a schematic view showing a configuration of another display medium according to a preferred embodiment of the present invention.

FIG. 4 is a schematic view showing a configuration of yet another display medium according to a preferred embodiment of the present invention.

FIG. 5 is a schematic view showing a configuration of still another display medium according to a preferred embodiment of the present invention.

FIG. 6 is a schematic view showing a configuration of yet another display medium according to a preferred embodiment of the present invention.

FIG. 7 is a schematic view showing a configuration of yet another display medium according to a preferred embodiment of the present invention.

FIG. 8 is a schematic view showing a configuration of still another display medium of according to a preferred embodiment of the present invention.

FIG. 9A is a schematic view showing a configuration of another display medium according to a preferred embodiment of the present invention.

FIG. 9B is a schematic view showing a configuration of yet another display medium according to a preferred embodiment of the present invention.

FIG. 10 is a schematic view showing a configuration of yet another display medium according to a preferred embodiment of the present invention.

FIG. 11A is a schematic view showing a configuration of still another display medium according to a preferred embodiment of the present invention.

FIG. 11B is a schematic view showing a configuration of still another display medium according to a preferred embodiment of the present invention.

FIG. 12 is a schematic view showing a configuration of display medium of a modification of the first preferred embodiment having an EL display element as the dynamic display medium.

FIG. 13A is a schematic view showing a configuration of display medium of a further modification of the first preferred embodiment having an EL display element as the dynamic display medium.

FIG. 13B is a schematic view showing a configuration of display medium of yet another modification of the first preferred embodiment having an EL display element as the dynamic display medium.

FIG. 14 is a schematic view showing an example of arrangement of a functional circuit in the display medium of various preferred embodiments of the present invention.

FIG. 15 is a schematic view showing another example of arrangement of the functional circuit in the display medium of various preferred embodiments of the present invention.

FIG. 16 is a schematic view showing a configuration of a display medium of another preferred embodiment of the present invention.

FIG. 17A is a schematic view showing a configuration of a display medium in the form of a book according to another preferred embodiment of the present invention.

FIG. 17B is a schematic view showing a configuration of a display medium in the form of a book according to a further preferred embodiment of the present invention.

### DETAILED DESCRIPTION OF PREFERRED EMBODIMENTS

With reference to the drawings, description will be provided below of a display medium according to preferred embodiments of the present invention.

As mentioned above, the term “information” as used in the description of preferred embodiments of the present invention means information that is a representation or expression of an idea, concept, story, etc., which is not merely an indicia or indication of the function of a button on the display, such as the keys on an electronic device such as a Personal Digital Assistant (PDA) or calculator having a dynamic display.

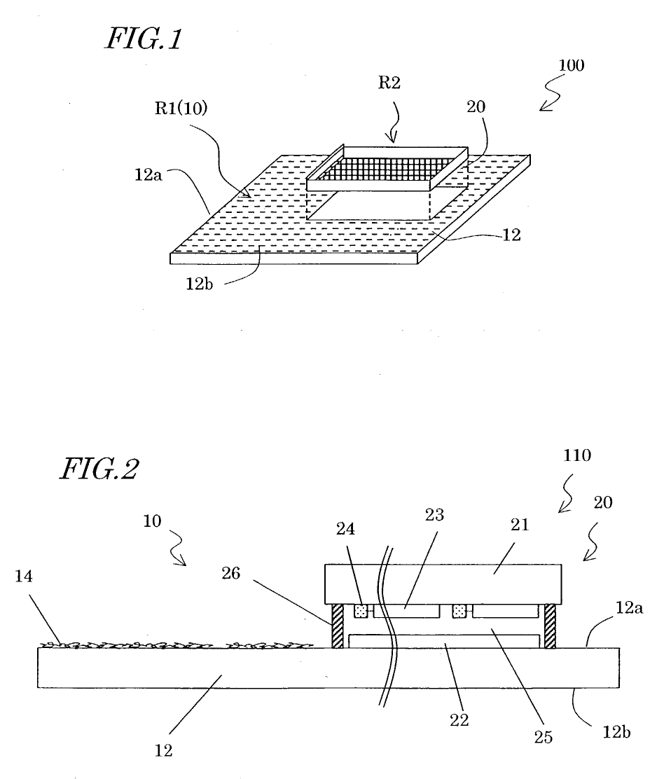

As schematically shown in FIG. 1, a display medium 100 according to a preferred embodiment of the present invention includes a static display medium 10 and a dynamic display medium 20. Information is statically displayed in a certain area (first area) R1 of a first main surface 12a of a sheet (for example, paper) 12 constituting the static display medium 10. A dynamic display medium 20 is provided in another area (second area) R2 of the first main surface 12a. That is, a portion of the sheet 12 including the first area R1 constitutes the static display medium 10.

It should be noted that in the preferred embodiment shown in FIG. 1, both the static information and dynamic information is preferably displayed on the first main surface 12a of the sheet 12. However, either or both of the static information and the dynamic information can be displayed on the second main surface 12b of the sheet 12.

In the preferred embodiment of FIG. 1, information is preferably displayed in the first area R1 of the first main surface 12a preferably using ink (including material such as dye, pigment, or toner which is used to display or record information on conventional paper or plastic film). The static display medium 10 is preferably manufactured by a well-known method using the well-known sheet 12 and ink (not shown). The dynamic display medium 20 may suitably be a well-known display element (for example, a liquid crystal display element, an EL display element, an electrophoresis display element (for example, an electrophoretic microcapsule ink type), a twist ball type display element, or an electronic toner display element).

The sheet 12 is typically paper and may be a plastic sheet. The ink used to display information on the sheet 12 and its first main surface 12a may be selected from a wide range of materials currently used for hard copies including printed matter. Further, in the description of the related art, the newspaper is illustrated as a static display medium. However, according to various preferred embodiments of the present invention, the static display medium provided with the advantages of the dynamic display medium is not limited to newspaper. FIG. 1 shows the display medium 100 in which the dynamic display medium 20 is provided on the one sheet 12. However, it is possible to bookbind a plurality of display media 100. On the other hand, if this display medium is utilized as a book, information may be statically displayed not only on the first main surface 12a of the sheet 12 but also on the second main surface 12b of the sheet 12. Furthermore, the dynamic display medium may be provided on the second main surface 12b of the book. Moreover, some of the plurality of sheets 12 constituting the book may be composed only of the static display medium.

If the dynamic display medium 20 is provided directly on the first main surface 12a of the sheet 12, e.g. if the sheet 12 has a fibrous structure such as paper, certain characteristics of the sheet such as its barrier function may be insufficient. Further, if the dynamic display medium 20 is detachable, certain characteristics of the sheet such as the durability of the surface may be insufficient. To compensate for these characteristics of the sheet 12, a protective layer is preferably provided on the surface of the area (R2) in which the dynamic display medium 20 is provided. Of course, the protective layer may also be provided in the area constituting the static display medium 10 as required. In this case, the protective layer is preferably formed so as to protect a printed surface of the static display medium. The configuration with the protective layer enables a wider range of materials to be used for the sheet 12. For example, paper with an excellent diffuse reflection characteristic can be suitably used as the sheet 12.

If the dynamic display medium 20 is provided on the sheet 12 such as a newspaper which has a large display area, it is preferably provided at a position at which, for example, does not hinder the sheet from being folded into four, so as not to impair the portability of the sheet.

Thus, the display medium 100 provided with the static display medium 10 and the dynamic display medium 20 achieves many advantages described below.

If, for example, the static display medium 10 is a newspaper, the dynamic display medium 20 is preferably provided in a section or location which conventionally has photographs or drawings. The use of the dynamic display medium 20 enables a plurality of photographs or drawings to be sequentially displayed within a limited space or enables moving pictures to be displayed. Accordingly, much information can be provided within a limited space or moving picture information can be provided, which cannot be provided by the static display medium. Thus, the present invention provides a display medium that gives the reader the feeling of being at the scene of an incident or event and provides much more detailed and illustrative information that is more interactive than with a conventional static display medium. Description will be provided later of a method of inputting information displayed by the dynamic display medium 20.

Japanese Laid-Open Patent Publication No. 2001-184141 discloses a portable information terminal device that reads a URI recorded on printed matter to obtain corresponding contents from the Internet for display. However, the portable information terminal device is separate and not integrated with the printed matter, and naturally, the user must hold the portable information terminal device and position it relative to the printed matter to read the URI. Furthermore, it is difficult to hold the portable terminal information device so that a display surface of the portable terminal information device is flush with a display surface of the print matter. Consequently, to observe the display on the portable terminal information device, the observer must move his or her line of sight significantly away from the display surface. This impairs the scanning function of the printed matter. As a result, the user has to suffer the inconvenience of being forced to move his or her line of sight to the portable terminal information device to view, for example, a moving picture display. Therefore, the user utilizes the scanning function less frequently.

In contrast, in the display medium 100 according to preferred embodiments of the present invention, the dynamic display medium 20 is fixed to and integrated with the display surface (main surface) of the static display medium 10. Accordingly, the user need not directly hold only the dynamic display medium 20. Further, the display surface of the dynamic display medium 20 is substantially flush with the display surface of the static display medium 10 (the thickness of the dynamic display medium is exaggerated in the figures for ease of explanation and illustration). This prevents the scanning function of the static display medium 10 from being impaired. Therefore, the user can view, for example, moving picture information without experiencing the inconveniences and problems described above. The information displayed by the dynamic display medium 20 is typically moving images or pictures. However, the information displayed may be a plurality of still images (for example, sequential pictures or drawings) or character information.

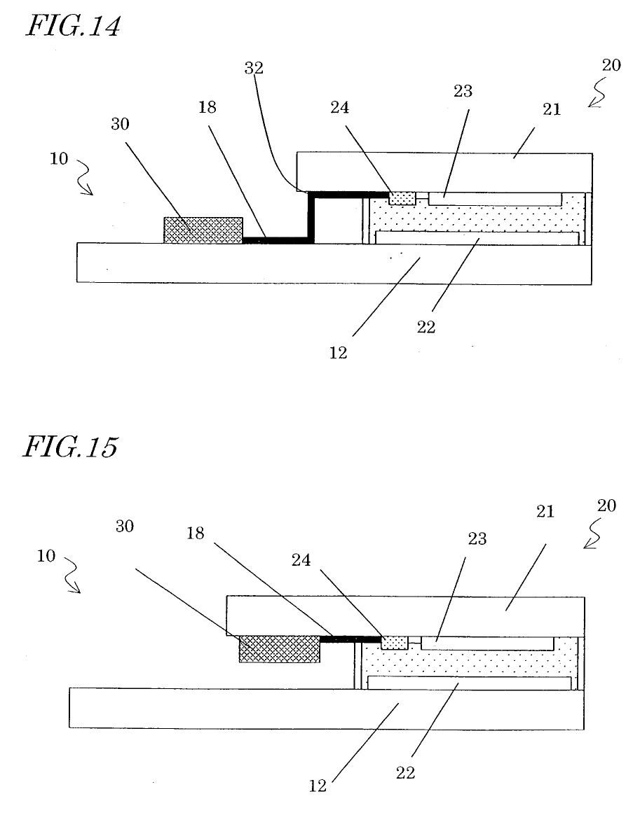

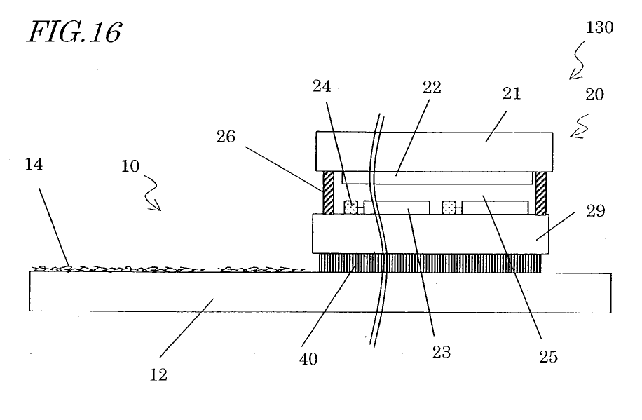

The dynamic display medium 20 may be integrated with the sheet 12, constituting the static display medium 10 (for example, FIG. 2), or may be detachably installed in the second area R2 of the sheet 12 (for example, see FIG. 14). The display medium 100 preferably includes a driving circuit and a power supply circuit both used to operate the dynamic display medium 20, a storage circuit that stores and transfers information to be displayed on the dynamic display medium 20, and/or a communication circuit that receives and transfers information to be displayed (none of these circuits are shown). These circuits may be provided in the dynamic display medium 20 or may be provided in the sheet 12 and electrically connected to the dynamic display medium 20 via wiring or other suitable connection.

The driving circuit is preferably integrated with a substrate constituting the dynamic display medium 20. If, for example, an active matrix type display element is used as the dynamic display medium 20, the driving circuit is preferably formed in an active matrix substrate constituting the dynamic display medium 20. For example, the active matrix substrate is preferably a flexible substrate having a plastic film and an organic transistor formed on the plastic film. This is so that the flexibility of the entire display medium 100 is not impaired. The flexible substrate is also effective in reducing the mass or thickness of the dynamic display medium as well as costs.

Various batteries may be used as the power supply circuit. For example, various primary or secondary batteries or solar or fuel batteries may be used. Further, sheet-like batteries are preferably used. If the display medium 100 is stored over a long period, all or a portion of the sheet 12, constituting the display medium 100, may be a sheet-like battery. Rather than providing the display medium 100 with batteries, it is possible to provide a power supply terminal to connect to an external power supply (for example, batteries) or an element that receives power from an external source by electromagnetic induction or the like in a non-contact manner. The power supply circuit or a portion of it (for example, batteries) may be made detachable from the display medium 100 as required.

The storage circuit may be possessed by a detachable storage medium such as a memory card, for example. Given that the display medium 100 may preferably be circulated like newspapers, the memory card may be provided as requested by the user when the display medium 100 is sold.

Further, if the display medium 100 is provided with the communication circuit, then for example, a URI for a site at which required display information can be obtained can be recorded in a portion of the static display medium 10 of the display medium 100. Then, the user can obtain information as required. In this case, the user may be charged when obtaining information or when being provided with the display medium 100. Further, certain information may be provided together with the display medium 100, with additional information provided as requested by the user. If the display medium 100 is provided with the communication circuit, information can be provided using various methods described in Japanese Laid-Open Patent Publication No. 2001-184141, described above.

Furthermore, if the dynamic display medium 20 is detachable, the common dynamic display medium 20 can be used for the plurality of second areas R2 included in the display medium 100. In this case, information about addresses assigned to the corresponding second areas R2 may be recorded in the display medium 100 so as to display predetermined information for each second area R2 when the dynamic display medium 20 is installed. Then, the information is provided to the user when he or she inputs this address information as required. Alternatively, a detection circuit may be provided in the dynamic display medium 20. Then, the detection circuit may read address information corresponding to the second area R2 in which the dynamic display medium 20 is installed, to obtain predetermined information from the storage circuit or a predetermined site.

Further, the detachable dynamic display medium 20 can be repeatedly used for periodicals such as newspapers. For example, only the sheet 12 containing the static display medium 10 can be purchased as required to obtain corresponding information to be displayed on the dynamic display medium 20. Information may be provided using the storage medium provided with a storage circuit such as a memory card or the communication circuit as described above.

For books, it is not advantageous that the dynamic display medium 20 is detachable. Accordingly, the dynamic display medium 20 may be formed on the sheet 12 similarly to the static display medium 10. In this case, it is not particularly necessary to make the storage circuit detachable, but a more inexpensive storage element may be used.

The dynamic display medium 20 is preferably, for example, a liquid crystal display medium (PDLC, FLC, AFLC, or other suitable display medium) or an electrophoretic display medium which has a memory function. When the dynamic display medium 20 has a memory function, if, for example, the dynamic display medium 20 is provided in the second area R2, in which still images (for example, photographs) are conventionally displayed, the display medium 100 can be provided to the user with the still images already displayed. The user can view the still images displayed on the dynamic display medium 20 and determine the necessity of further information before operating the dynamic display medium 20. This is very convenient and saves power.

Whether the dynamic display medium 20 is detachable or fixed is appropriately selected depending on information provided. The manner of providing information displayed on the dynamic display medium 20 is appropriately selected depending on the application of the display medium 100 (that is, the type of information to be displayed). In either case, a display medium in a reflection mode is preferably used as the dynamic display medium 20. This is because the display medium 100 displays information on the same plane as that of the static display medium 10 and because the static display medium 10 preferably utilizes ambient light (that is, reflection mode display). Thus, the dynamic display medium 20 preferably provides a favorable display in a situation where a display provided by the static display medium 10 is successfully observed. Further, the reflection type display medium also has the advantage of consuming less power because it does not require any light sources. Furthermore, if the reflection type display medium utilizes a diffuse reflection layer (which may be referred to as a “scattering layer”) as in the case with a typical reflection type liquid crystal display medium, then the sheet 12 can be utilized as a diffuse reflection layer. In this case, the reflection type display medium may be fixed to the first main surface 12a of the sheet 12 or may be detachable from the sheet 12.

Description will be given below of a fixed display medium (Preferred Embodiment 1) in which the dynamic display medium 20 is integrated with the sheet 12 and a detachable display medium (Preferred Embodiment 2) in which the dynamic display medium 20 can be removed from the sheet 12.

Preferred Embodiment 1

FIG. 2 schematically shows the sectional structure of a display medium 110 of Preferred Embodiment 1. The display medium 110 is provided with the first area R1 in which the static display medium 10 displays still images and the second area R2 in which the dynamic display medium 20 displays moving images or pictures, the first and second areas R1 and R2 preferably being located on the same first main surface 12a of the sheet 12 (see FIG. 1). The dynamic display medium 20 included in the display medium 110 is, for example, preferably a reflection type liquid crystal display element 20, or other suitable dynamic display.

A pattern 14 of static information such as printed alphanumeric characters is formed in the first area R1 of the sheet 12. A common electrode 22 of the reflection type liquid crystal display element 20 is formed in the second area R2 of the sheet 12. The common electrode 22 is provided as an electric member required to drive a display medium layer (for example, a liquid crystal layer) 25 disposed thereon. The liquid crystal layer 25 is provided on the common electrode 22, located in the second area R2, with an active matrix side substrate (including a film) 21 provided on the liquid crystal layer 25. A side of the active matrix side substrate 21 which is closer to the liquid crystal layer 25 is provided with thin film transistors (TFTs) 24 and pixel electrodes 23. The liquid crystal layer 25 is provided between the pixel electrodes 23 and the common electrode 22. The reflection type liquid crystal display element 20 has a well-known structure. It is not limited to a 3-terminal element such as a TFT but may be a 2-terminal element such as an MIM element.

The display medium 110 is provided with both a static display medium and a dynamic display medium 20 preferably on the same surface. It can thus display moving images or pictures (video display) instead of still images such as photographs or pictures compared to conventional printed matter (a newspaper, for example), notably that containing articles and related photographs or pictures. The display medium 110 can thus provide a display that gives the user the feeling of being at the scene of an incident or event.

Further, the sheet 12 is preferably used both for the static display medium 10 in the first area R1 and for the dynamic display medium 20 in the second area R2. This simplifies the configuration and allows common members to be used for different purposes, thus reducing costs.

Furthermore, a good diffuse reflection characteristic can be obtained when the sheet 12 is formed of paper or other suitable material which has a fibrous structure. Consequently, the sheet 12 can be used as a diffuse reflection layer by forming the common electrode 22 using a transparent conductive material (for example, ITO). This simplifies the structure of the dynamic display medium 20 as well as a manufacturing process therefor. Further, the costs can be further reduced by using a common material or process to form a member forming the pattern 14 constituting the static display medium 10 (this member will hereinafter be simply referred to as “ink”) and a member constituting the dynamic display medium 20 as described later.

In FIG. 2 and other figures, the display medium is shown as enlarged in its thickness direction for easy understanding. However, the sheet-like dynamic display medium 20 (having a thickness of, for example, about 5 mm or less) is formed on the first main surface 12a of the sheet 12. The entire display medium 110 can be made flexible by using a flexible substrate (for example, a plastic film) as the active matrix side substrate 21 of the dynamic display medium 20.

Then, description will be provided of a specific example of each member of the display medium 110 and a variation of the display medium 110.

The characteristics of the sheet 12 are not particularly limited as long as it is shaped like a sheet. The sheet 12 is preferably made of a material such as a plastic sheet, a metal sheet, a ceramic sheet (including a glass sheet), or a fibrous structure such as paper. The display medium according to preferred embodiments of the present invention is preferably composed of a flexible material so as to make a relatively large area (for example, A4 or larger, and more preferably, B4 or larger) available,. which is especially convenient, and to suitably replace newspapers or print matter. More preferably, the display medium is composed of a plastic sheet, a fibrous structure such as paper, or a thin metal sheet.

Further, as shown in FIG. 3, a protective layer (for example, a resin film) 16 may be provided in order to provide the surface of the sheet 12 with characteristics such as moisture resistance, chemical resistance, environmental resistance, dust resistance, surface flattening properties, and insulating properties. In particular, for a sheet of a fibrous structure such as paper, the protective layer 16 preferably made of a resin film is preferably provided before forming an electric member in the second area R2 so as to provide dust resistance, flattening properties, and chemical resistance. For example, as shown in FIG. 3, the protective layer 16 is formed substantially all over the area of main surface of the sheet 12 before forming the pattern 14 in the static display medium 10 or the dynamic display medium 20.

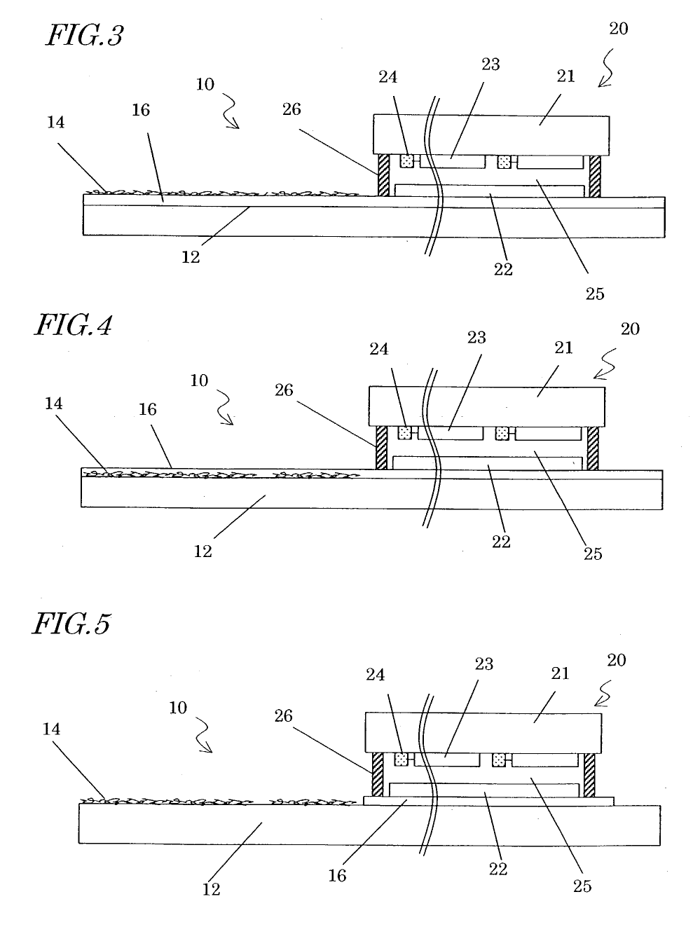

Alternatively, as shown in FIG. 4, after the pattern (for example, printed characters) 14 has been formed on the main surface of the sheet 12, the protective layer 16 may be formed so as to cover the pattern 14. This enables the pattern (for example, printed characters) 14 to be protected during a process of forming the dynamic display medium 20 in the second area R2. It is thus possible to widen the range of ink materials one of which is selected to form the pattern 14. This facilitates the utilization of various well-known print inks conventionally used.

Alternatively, as shown in FIG. 5, the protective layer 16 may be selectively formed in the second area R2 of the sheet 12, i.e. the area in which the dynamic display medium 20 is formed. The protective layer 16 is preferably provided on the surface of the second area of the sheet 12 because this surface must be flat and resistant to moisture so as to form an electrode in this area. However, it is possible to omit the formation of the protective layer 16 in the first area R1. If paper is used as the sheet 12, print ink is arranged directly on the surface of the paper, with nothing formed on the print ink. Accordingly, in the first area R1, the matter printed on the paper can be clearly viewed. The protective layer 16 is desirably removed from the first area R1 after the dynamic display medium 20 has been formed, taking into account process resistance offered when the dynamic display medium 20 is formed in the second area R2.

FIG. 6 shows a structure in which a metal sheet 12A is used as the sheet 12 and in which a second main surface 12b of the second area R2 of the sheet 12A is also used as a common electrode (see the common electrode 22 in FIG. 2). This structure allows for omission of a step of separately forming the common electrode 22 in FIG. 2. Further, characters printed on the surface of the protective layer 16 can be more clearly viewed by using a white insulating material (a resin sheet containing white pigments or having diffuse reflection properties) as the protective layer 16 in the first area R1. Furthermore, the second main surface 12b of the sheet 12, preferably composed of metal, functions as a common electrode in the second area R2. Consequently, if, for example, a liquid crystal layer 25 is used as a display medium layer 25, a reflection type display can be implemented using a simple structure if the sheet 12 is used as a reflection electrode.

As a method for driving the dynamic display medium 20 in the second area R2, although a simple matrix method can be applied, an active matrix method is preferable in view of the display quality.

In order to use an active matrix method, an active element is preferably provided for each of the pixels. As the active element, for example, a TFT using an amorphous silicon film, a poly-silicon film, continuous grain silicon (CG silicon) film or an organic semiconductor film is preferably used. In addition, an MIM element, a back-to-back diode element, or ferroelectric nonlinear element can also be used. Among these active elements, it is most preferable to use a TFT, because of its relatively low driving voltage and superior switching characteristics.

The TFTs can be formed on the sheet 12 and base 21 by a well-known process.

As for the process for forming the active elements, it is preferable to adopt a printing technology (e.g., ink-jet technology, offset printing technology or other suitable printing technology), because the static display medium in the first area R1 is generally formed by using a printing technology. Both the dynamic and static display media can be formed by the same printing technology to reduce the fabrication cost.

For example, a metal electrode of the TFT can be formed by an ink-jet printing method using a conductive ink including metal ions, ultra-fine metal particles and/or electro conductive polymer, or other suitable material.

An electro conductive oxide film can be formed by an ink-jet printing method using a sol-gel solution including a metal ion or a solution including a metal complex, or other suitable material. An insulating film can be formed by an ink-jet printing method using an organic insulating material such as polyimide, or other suitable material. A semiconductor film can also be formed by an ink-jet printing method using a solution including an organic semiconductor material, or other suitable material. A baking step may be performed after each of the printing steps, if necessary.

For example, a TFT formation method described by “Ink-jet Printed Polymer Thin Film Transistors for Active-Matrix Display Applications”, SID Digest 2002, pp.1193-1195 (2002) can be used.

Furthermore, a transfer technology is preferably applied in order to form the TFTs, when the sheet 12 and/or the substrate 21 are made of a material (e.g., plastic) which is poor in heat resistance or chemical resistance. That is, the TFTs can be formed on another substrate (e.g., glass, quartz or silicon substrate) having sufficient resistance against heat and chemicals resistance and then transferred to the sheet 12 and/or the substrate 21.

By utilizing the transfer technology, it is advantageous in that a variety of materials for the sheet 12 and/or the substrate 21 can be used and the process for forming the TFTs can be optimized regardless of the materials used for the sheet 12 and/or the substrate 21.

As an example of a transfer process for the TFTs, a method described by “Low Temperature Poly-Si TFTs on Plastic Substrate Using Surface Free Technology by Laser Ablation/Annealing”, SID Digest 2000, pp.916-919 (2000) and “Low-Temperature Polycrystalline-Silicon TFT Color LCD Panel Made of Plastic Substrates”, SID Digest 2002, pp.1196-1199 (2002) can be used.

The dynamic display medium 20, provided in the second area R2, may preferably be composed of a well-known thin display element described in Nikkei Science February 2002 (on the market on Dec. 25, 2001) pp. 42 to 51, mentioned above, e.g. a liquid crystal display element, an EL display element, an electrophoretic display element, an electronic toner type display element utilizing the movement of black grains (toner or other suitable material), or a ball twist display element utilizing the rotation of a ball. In particular, a structure is preferable which uses a thin (for example, a thickness of about 5 mm or less) display medium that is as flexible as the sheet 12.

FIGS. 2 to 6, described above, illustrate a structure in which a liquid crystal layer is preferably used as the display medium layer 25. In the display medium in FIGS. 2 to 6, for example, a flexible and transparent plastic sheet (film) is preferably used as the substrate 21, constituting the dynamic display medium 20.

A large number of active elements (for example, amorphous silicon films, continuous grain boundary silicon films, or thin film transistors (TFT) formed using organic semiconductor films) 24 and pixel electrodes 23 formed using transparent conductive materials (for example, ITOs) are preferably formed in a matrix on the surface of the substrate 21 arranged opposite the sheet 12 via the liquid crystal layer 25 which is closer to the liquid crystal layer 25. Of course, signal lines through which data signals are transmitted by the corresponding pixel electrodes 23 and scanning lines used to sequentially drive the active elements are provided on the substrate 21. However, their illustration is omitted. The substrate 21 and the previously described sheet 12 are arranged so that the pixel electrodes 23 correspond to the common electrode 22 via the liquid crystal layer 25. The liquid crystal layer 25 is sealed using a seal material (seal portion) 26 arranged so as to surround the periphery of the substrate 21. Thus, the liquid crystal is prevented from leaking to the exterior. When the dynamic display medium 20 is thus formed in the second area R2 of the sheet 12, the liquid crystal layer 25 is driven by a voltage applied between the pixel electrodes 23 and the common electrode 22. If a display medium layer other than the liquid crystal layer 25 is used, each display medium layer may be correspondingly replaced. Further, the common electrode 22 may be a reflection type composed of metal such as Al or Ag, or other suitable material. Alternatively, a reflection type display element may be constructed utilizing the reflection characteristic of the sheet 12 or the protective layer 16, provided on the sheet 12, by forming the common electrode 22 using a transparent conductive material such as an ITO or an organic conductive material.

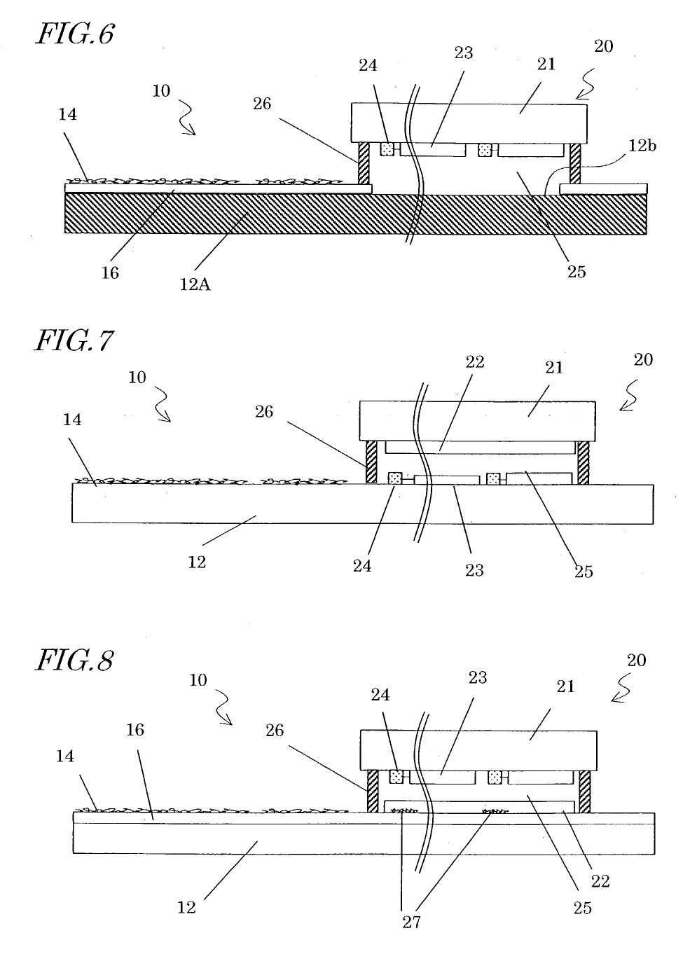

In contrast with the example shown in FIGS. 2 to 6, the common electrode 22 may be formed on the sheet 12, while the active elements 24 and the pixel electrodes 23 may be formed on the substrate 21, for example, as shown in FIG. 7. In this regard, a process of forming the active element 24 for each pixel requires a micromachining technique for thin films. It is thus easier to produce a configuration with a smaller area in which the active elements 24 and others are formed on the side of the substrate 21 on which the static display medium is not present. Further, the process can be more easily optimized for such a configuration.

Now, description will be given of an example of a manufacturing method of using ink forming the pattern 14 constituting the static display medium 10, as a material forming a member constituting the dynamic display medium 20 or forming the ink and the material using a common process.

For example, the pattern 14 in the first area R1 and the electric member in the second area R2 are preferably formed using a common conductive material. It is contemplated that conductive ink (for example, a black conductive resin) or a thin metal film may be used as the conductive material. If a conductive ink is used, various well-known printing methods can be utilized.

If a thin metal film is used, an electroless wet plating method can be used to form both a metal film in the first area R1 as the pattern 14 constituting the static display medium 10 and a metal film in the second area R2 as the electric member constituting the dynamic display medium 20, all over the surface of the sheet 12. Subsequently, an etching process can be used to carry out patterning to simultaneously form these metal films. For example, with an electroless Ni plating method using hydrazine as a reducing agent (the method disclosed in Surface Technology, Vol. 53, No. 1, pp. 31 to 33, 2002), a black Ni film can be formed on the substrate. Then, this black Ni film is formed into the pattern 14 of still or static images or characters. The pattern 14 can also be used as a wiring/electrode material for the dynamic display medium 20. However, if paper or the like us used as the sheet 12, the protective layer 16 such as the one shown in FIG. 3 is preferably formed on the sheet 12 (preferably both front and back surfaces of the sheet 12) in order to improve process resistance.

Alternatively, instead of the conductive ink, a metal precursor solution (an organic metal material or other suitable material) of a liquid, a conductive resin, metal ultrafine grains such as Cu or Au can be formed into a pattern using a jetting method. Furthermore, a conventional transfer or printing method can be used to form a metal film pattern or a conductive resin pattern.

Further, if the dynamic display medium 20 has a black matrix 27 as shown in FIGS. 8 and 9A, then an increase in the number of processes can be prevented by forming the black matrix 27 in the second area R2 using the same material and step as that used to form the pattern 14 (for example, printed characters) in the first area R1. In the structure shown in FIGS. 8 and 9A, the black matrix 27 is preferably provided under the common electrode 22. This structure is thus effective if the common electrode 22 is composed of a transparent material (for example, an ITO or an organic conductive material). The pattern 14 and the black matrix 27 may be formed directly on the surface of the sheet 12 as shown in FIGS. 8 and 9A or may be formed on the protective layer 16 formed on the surface of the sheet 12.

The black matrix 27 is often formed in a matrix in order to partition the pixels or prevent extraneous light from entering the active elements (for example, with the structure shown in FIGS. 8 and 9A, the black matrix 27 prevents extraneous light reflected by the sheet 12 from entering the active elements 24). Further, the black matrix 27 is also applicable if the active elements 24 are formed on the sheet 12 as shown in FIG. 7.

For example, as shown in FIG. 9B, after having formed the active element 24 and pixel electrode 23 on the surface of seat 12, the black matrix 27 in the second area R2 may be formed by using the same materials and process as those used for forming the pattern (a printed letter, for example) 14 in the first area R1.

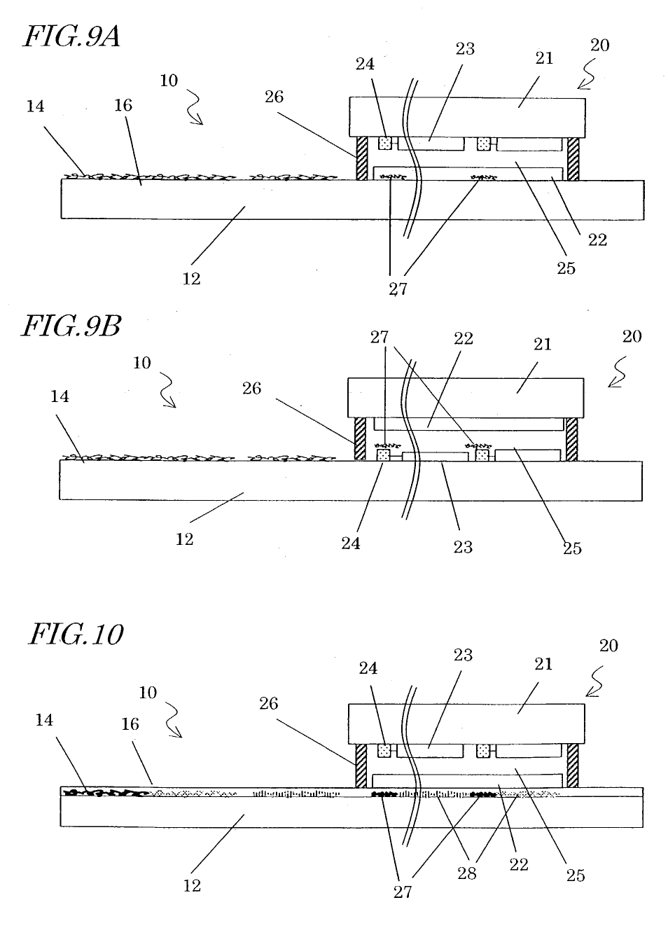

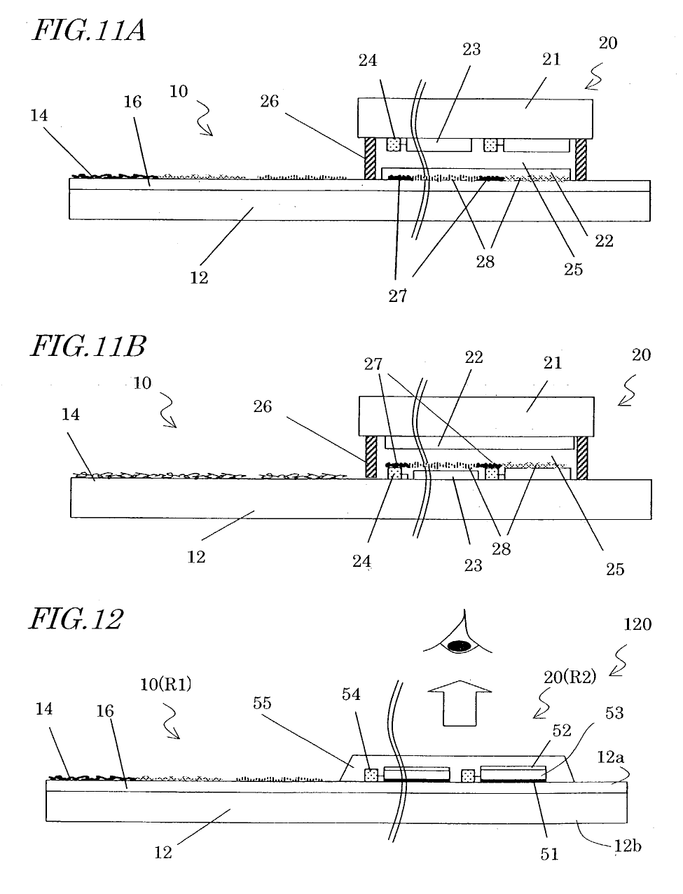

Furthermore, if the dynamic display medium 20 has the black matrix 27 and color filters 28 as shown in FIGS. 10 and 11A, an increase in the number of processes can be prevented by forming the black matrix 27 and color filters 28 in the second area R2 using the same material and step as those used for forming the pattern (for example, print characters) 14 in the first area R1. In this structure, the black matrix 27 is preferably provided under the common electrode 22. This structure is thus effective if the common electrode 22 is composed of a transparent material (for example, an ITO or an organic conductive material). Further, this structure is also applicable if the active elements 24 are formed on the sheet 12 as shown in FIG. 7.

For example, as shown in FIG. 11B, after having formed active element 24 and pixel electrode 23 on the surface of seat 12, the black matrix 27 and color filters 28 in the second area R2 may be formed by using the same materials and process as those used for forming for the pattern 14 (a printed letter, for example) in the first area R1.

Modification of Preferred Embodiment 1

The display medium 120 of a modification of the first preferred embodiment described above having an EL display element as the dynamic display medium will be described with reference to FIG. 12.

As shown in FIG. 12, an organic EL display element 20 and a TFT 54 are preferably formed in the second area R2 of the first main surface 12a of the substrate 12.

The EL display element has a reflection electrode 51, an organic EL layer 53, and a transparent electrode 52 in this order from the first main surface 12a of the substrate 12.

The reflection electrode 51 is preferably formed of Al alloys. The transparent electrode 53 is preferably formed of ITO or Indium Zinc Oxide. The organic EL layer 52 may be formed by using a polymer material or a low molecular weight material.

Instead of the organic EL layer 52, an electronic transportation layer or a hole transportation layer may be formed in combination with an organic emission layer.

A barrier layer (or passivation layer) 55 is preferably formed at the top of the EL display element to protect from oxygen and/or water.

The EL display element shown in FIG. 12 has a so-called top emission configuration wherein the transparent electrode is provided on the observer side surface and the display image is formed by the light transmitted through the transparent electrode.

By using the EL display element as the dynamic display medium, unlike the liquid crystal display element, it is not necessary to provide a counter substrate opposing the substrate. Therefore, the display medium can be thinner.

In addition, in the case where the organic EL layer is made of polymer material, the organic layer may be formed by a printing technology (e.g., ink-jet method). Since the static display medium is generally formed by a printing technology, the static and dynamic display media can be formed by a printing technology to simplify the fabrication process.

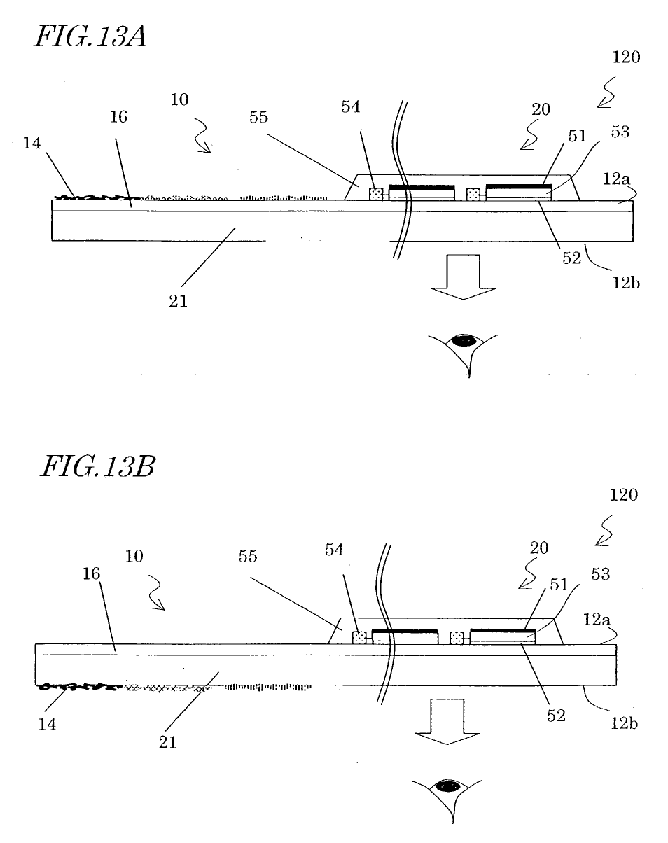

The EL display element of the display medium shown in FIG. 13A preferably has a so-called bottom emission configuration and like reference numerals with respect to those used in FIG. 12 are used in FIG. 13A, and repetitive description of these common elements is omitted. The EL display element 20 has a transparent electrode 52, an organic EL layer 53, and a reflection electrode 51 in this order from the first main surface 12a of the substrate 12. A barrier layer (or passivation layer) 55 is formed at the top of the EL display element to protect from oxygen and/or water. The display image is formed by the light transmitted through the substrate.

According to this configuration, it is further advantageous in that the observer side surface of the display medium is flat. As a matter of course, the substrate must be transparent. A plastic substrate or a glass substrate is preferable. Thus it is preferable in this case to use transparent materials (transparent plastics) as a supporting substrate.

The display medium shown in FIG. 13B is different from the display medium shown in FIG. 13A in that the static display medium in formed on the observer side surface of the substrate. However, like reference numerals used in FIGS. 12 and 13A are used in FIG. 13B, and repetitive description of these common elements is omitted.

In this configuration, the static display medium is observed directly (not through the substrate as FIG. 13A). Therefore, the information displayed by the static display medium is more clearly observed in the display medium of FIG. 13B.

To drive the dynamic display medium 20 in the second area R2, it is necessary to provide a storage circuit that stores image data displayed by the dynamic display medium 20, and a power supply circuit and a driving circuit used to operate the dynamic display medium 20 (all these circuits will hereinafter be collectively referred to as a “functional circuit 30”).

FIG. 14 schematically shows a configuration in which the functional circuit 30 is disposed on the sheet 12. This configuration is provided with an electrode transfer (sometimes simply referred to as a “transfer”) 32 that enables the sheet 12 and the substrate 21 to be electrically connected together so as to input an image signal formed by the functional circuit 30, provided on the sheet 12, to the active elements (TFTs) on the sheet 12. The electrode transfer 32 is formed using, for example, an anisotropic conductive adhesive (ACP or ACF) and is electrically connected to wiring 18. This structure is suitable for a storage circuit and a driving circuit including LSI chips and mounted on the sheet 12. The wiring 18 can be formed of, for example, conductive ink using the same step as that for forming the pattern 14.

Further, FIG. 15 schematically shows a structure in which the functional circuit 30 is provided on the substrate 21 of the dynamic display medium 20. This configuration does not require the electrode transfer 32 as shown in FIG. 14. A mounting process for the storage and driving circuit can be simplified by monolithically forming these circuits on the sheet 12 using a process of forming the active elements 24. To monolithically form the functional circuit, it is desirable to use a polysilicon TFT technique. In this regard, one or two of the storage, driving, and power supply circuits may be formed on the sheet 12, while the remaining circuits may be formed on the substrate 21, as required. Further, as described above, a communication circuit may be provided instead of or together with the storage circuit.

Preferred Embodiment 2

The information display medium 110 of Preferred Embodiment 1, described above, is of the type in which the dynamic display medium 20 is formed directly on the sheet 12. In contrast, a display medium 130 of Preferred Embodiment 2 is of the type in which the dynamic display medium 20 is detachably mounted on the sheet 12.

Like FIGS. 2 to 15, FIG. 16 corresponds to the sectional view in FIG. 1 and shows the corresponding structure enlarged in its thickness direction for easy understanding.

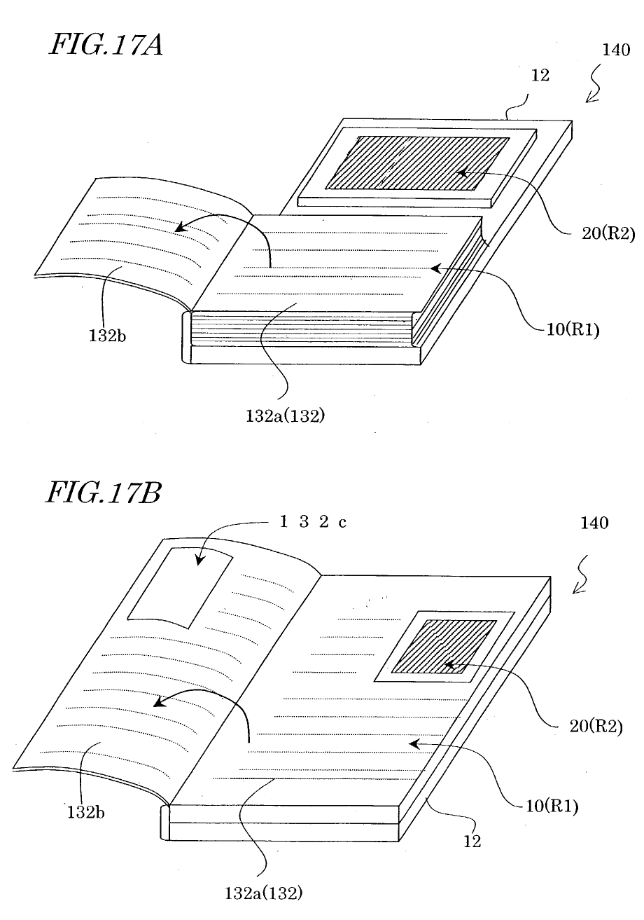

In a display medium 130, shown in FIG. 16, the dynamic display medium 20 is detachably held on the sheet 12 preferably using an adhesive layer 40. As opposed to Preferred Embodiment 1, it is impossible to form a part of a constituent member of the dynamic display medium 20 using the ink forming the pattern 14. However, this display medium is advantageous in that the dynamic display medium 20 can be repeatedly used. If the dynamic display medium 20 is constructed using a reflection type display element, the sheet 12 can be utilized as a diffuse reflection layer.

Variable devices and materials can be used to hold the dynamic display medium 20 in the second area R2 of the sheet 12. However, the holding devices/materials can desirably be held and removed a plurality of times. This is because compared to the sheet 12 provided with the static display medium 10, the information in the dynamic display medium 20 can be changed or rewritten, so that only the dynamic display medium 20 is desirably reused. Thus, a user of the display medium 130 of the present invention can obtain information in the above-described manner by buying only a new sheet 12 provided with the static display medium 10 and sticking the dynamic display medium 20 to the sheet 12. Fixing members that can be held and removed a plurality of times may include the illustrated method of using the adhesive layer 40, a method of utilizing a magnetic sheet to hold the dynamic display medium 20 by magnetic force, or a method of utilizing the principle of VELCRO™ to hold the dynamic display medium 20.

In this situation, the information to be displayed by the dynamic display medium may be updated to be consistent with the contents of the new static display medium. Update of the information of the dynamic display medium can be performed by downloading the information via an electronic communication (e.g., through Internet via radio or cable communication). Alternatively, the information for the dynamic display medium may be updated by buying a memory card, for example, with the new sheet 12.

As in the case with the display medium 110 of Preferred Embodiment 1, the dynamic display medium 20, provided in the second area R2, may utilize a liquid crystal display element, an EL display element, an electrophoretic display element, an electronic toner type display element, or a ball twist display element.

Further, the functional circuit (storage circuit, power supply circuit, and driving circuit) 30 for operating the dynamic display medium 20, may be disposed either on the sheet 12 or on the dynamic display medium 20 as in the case with Preferred Embodiment 1. If the functional circuit 30 is disposed on the dynamic display medium 20, the mounting process for the storage and driving circuits is preferably simplified by monolithically forming these circuits on the sheet 12 using the process of forming the active elements 24. Of course, as in the case with Preferred Embodiment 1, a communication circuit may be provided instead of or together with the storage circuit.

Preferred Embodiment 3

The display medium of the first preferred embodiment of the invention is different from the display medium of the second preferred embodiment in that the static display medium and the dynamic display medium are formed as one unit. That is, the static display medium and the dynamic display medium share some components. Therefore, it is impossible to reuse (recycle) only the dynamic display medium 20.

However, it is preferable to reuse the display medium of the first preferred embodiment, since it includes the dynamic display medium.

A recycling method of a display medium shown with respect to preferred embodiment 1 will be described hereafter.

It is preferable to update the information to be displayed by the display medium in order to recycle the display medium.

As for the information for the dynamic display medium, the information can be easily updated electrically.

On the other hand, it is rather difficult to update the information for the static display medium, since the information is generally printed on the sheet.

The information displayed by the static display medium can be changed or rewritten in the following manner, for example.

In the present preferred embodiment, the information for the static display is preferably printed in the first area R1 by using a material (e.g., ink) which is erasable or decolorable in response to a chemical reaction. After using the information medium, by conducting the erasing or decoloring step, the first area R1 is left blank and new information can be recorded or printed in the first area R1.

Along with updating of the information for the static display medium, the information for the dynamic display medium may also be updated. That is, in the second area R2, the hardware of the dynamic display medium is recycled and preferably only software (display information) is updated.

An example of the erasable or decolorable material is ink including a pigment, a color development agent and a decoloring agent.

In the as-printed state, this ink is in a coloring state and forms a display image. The color development agent (i.e., coupler) forms a chemical bond with the pigment to form the coloring state.

The erasing or decoloring step to break the chemical bond between the pigment and the color development agent is conducted by an application of energy such as heat or radiation (e.g., light). Alternatively, the erasing or decoloring step can be conducted by applying a chemical (e.g., a decoloring agent or solvent) to the erasable or decolorable material. Thus, the erasing or decoloring agent forms a chemical bond with a free color development agent to achieve the erased or decolored state.

For example, as decolorable ink, a material described in Japanese Patent Laid-Open Publication No. 2000-19770 can be used.

Alternatively, a toner or ink, which can be erased by a chemical reaction and/or physical abrasion, can be used appropriately. In this specification, “decolorable material” includes decolorable ink and a toner.

Although the above-mentioned decolorable materials are preferably used, a non-decolorable material (ink or toner) maybe used. In this case, the information printed in the first region R1 can be erased by finishing it with a coat, of white ink (ink having the same color as the sheet).

As mentioned above, the information display medium can be recycled. According to preferred embodiments of the present invention, a recyclable newspaper, book, catalogue, advertisement, and calendar, which include dynamic display, medium can be provided.

Preferred Embodiment 4

In the above-mentioned preferred embodiments 1 through 3, the static display medium and the dynamic display medium are respectively formed in the first area R1 and the second area R2 of the same surface of the sheet, and the static display medium includes the sheet. However, the present invention is not limited to these preferred embodiments. That is, the static display medium may include additional sheets other than the sheet on which the dynamic display medium is formed. For example, the static display medium may be in the form of a booklet.

The display medium 140 of the fourth preferred embodiment in which the static display medium 10 is in the form of a booklet will be described with reference to FIGS. 17A and 17B. The static display medium 10 of this preferred embodiment preferably includes a plurality of additional sheets 132 and each of the additional sheets preferably corresponds to a single image displayed by the dynamic display medium 20, for example. The static information may be provided on either or both of the first main surface 132a and the second main surface 132b of the sheets 132.

The user of the display medium 140 turns a page of the static display medium 132 and the image on the dynamic display 20 medium may be electronically refreshed.

It is preferable that the dynamic display medium 20 may have a function of recognizing the page of the additional sheets 132 currently viewed by the user and refreshing the dynamic display image in response to the current page automatically.

For example, a notch 132c may be formed in the upper part of each page of the static display medium. The positions of the notches 132 differ page by page. An optical sensor (not shown) may be buried in the sheet (i.e., last page) at a position corresponding to the notch.

By specifying a combination of the optical sensors, it is possible to determine the page at which the user is currently viewing.

Alternatively, an information refresh button may be provided near the dynamic display medium. The dynamic display medium 20 refreshes the image in response to an operation of the information refresh button by the user.

The display medium 120 of the forth preferred embodiment may be more cost effective than others, since a single dynamic display medium can be used for more information to be displayed by the static display medium. According to the present preferred embodiment, high value added recyclable newspapers, catalogues, advertisements or calendars can be provided.

According to preferred embodiments of the present invention, a display medium is provided which has the advantages of both static display media and dynamic display media. Since the present display medium is provided with the dynamic display medium, a plurality of photographs or drawings or movable images can be sequentially displayed within a limited space. Therefore, much information can be provided to a user using a limited space. Alternatively, moving picture information, which cannot be provided using a static display medium, can be provided to the user. The display medium of preferred embodiments of the present invention has an advantage in that the display medium as a whole has an excellent scanning function like a static display medium.

It should be understood that the foregoing description is only illustrative of the present invention. Various alternatives -and modifications can be devised by those skilled in the art without departing from the present invention. Accordingly, the present invention is intended to embrace all such alternatives, modifications and variances which fall within the scope of the appended claims.

What is claimed is:

1. A display medium comprising:
a sheet having a first main surface and a second main surface opposite to each other;
a first area where information is statically displayed; and
a second area where information is dynamically displayed.

2. The display medium of claim 1, wherein the information is displayed in the first area of the first main surface and a dynamic display medium is provided in the second area of the first main surface.

3. The display medium according to claim 2, wherein said dynamic display medium includes a member formed of the same material as that used to display the information that is statically displayed.

4. The display medium according to claim 2, wherein said dynamic display medium is a reflection type display medium utilizing said sheet as a reflection layer.

5. The display medium according to claim 2, wherein the information is displayed in said first area using at least one type of ink, and said dynamic display medium has a plurality of pixels, and a light blocking layer that prevents light from passing between said plurality of pixels is made of ink included in said at least one type of ink.

6. The display medium according to claim 5, wherein said active matrix type display element is flexible.

7. The display medium according to claim 2, wherein the information is displayed in said first area using plural types of inks including inks of a plurality of different colors, and said dynamic display medium has a plurality of pixels and color filters provided so as to correspond to said plurality of pixels and made of said inks of the plurality of different colors.

8. The display medium according to claim 2, wherein the information is displayed in said first area using at least one type of ink including conductive ink, and said dynamic display medium has a plurality of conductive members at least some of which are made of said conductive ink.

9. The display medium according to claim 8, further comprising at least one of a power supply circuit, a driving circuit, and a storage circuit in an area of said sheet that is different from said first area, and said at least one circuit and some of said plurality of conductive members included in said dynamic display medium are electrically connected together via wiring made of said conductive ink.

10. The display medium according to claim 1, wherein said sheet is flexible.

11. The display medium according to claim 1, wherein said sheet has a base material and a protective layer provided in at least a second area of said base material.

12. The display medium according to claim 1, wherein said sheet has a base material having a fibrous structure.

13. The display medium according to claim 2, wherein said dynamic display medium is removably mounted on said sheet.

14. The display medium according to claim 13, wherein said dynamic display medium is a reflection type display medium utilizing said sheet as a reflection layer.

15. The display medium according to claim 2, wherein said dynamic display medium has at least one of a power supply circuit, a driving circuit, and a storage circuit.

16. The display medium according to claim 2, further comprising at least one of a power supply circuit and a driving circuit, in an area of said sheet that is different from said first area, and said at least one circuit and said dynamic display medium are electrically connected together via wiring disposed in said sheet.

17. The display medium according to claim 2, wherein said dynamic display medium is an active matrix type display element.

18. The display medium according to claim 17, wherein said active matrix type display element is flexible.

19. The display medium according to claim 1, wherein a plurality of sheets, on which information is statically displayed, are provided in the first area of the main surface of said sheet.

20. The display medium according to claim 2, wherein a material which is used to display information in the first area is decolorable so as to change into a decolored state in response to a chemical reaction.

21. The display medium according to claim 2, wherein the dynamic display medium has a transferred active element that is independently formed and transferred to the sheet.

22. The display medium according to claim 1, wherein a static display medium is located in said first area and a dynamic display medium is located in said second area, the static display medium and the dynamic display medium are substantially flush with one of the first main surface and the second main surface of the sheet.

23. The display medium according to claim 22, wherein the static display medium and the dynamic display medium share at least one common element including one of a conductive ink, a black matrix and a color filter.

24. The display medium according to claim 22, wherein each of the static display medium and the dynamic display medium is integrated in the sheet and forms a portion of the sheet.

25. A display comprising:
a sheet having a first main surface, information being statically displayed in a first area of said first main surface; and
a dynamic display medium, which dynamically displays information, provided on a second main surface of the sheet opposite to the first main surface such that the dynamically displayed information is observed through a second area of the first main surface.

26. A method of forming a display medium comprising the steps of:
providing a sheet having a first main surface and a second main surface opposite to each other;
forming statically displayed information in a first area; and
forming dynamically displayed information in a second area.

27. The method according to claim 26, wherein a material which is used to form the statically displayed information in the first area is decolorable, and further comprising the step of applying a material to the statically displayed information in the first area so as to change the decolorable material into a decolored state in response to a chemical reaction, and forming new statically displayed information in the first area.

28. The method according to claim 26, further comprising the steps of forming a dynamic display medium separate from the sheet and transferring the dynamic display medium to the sheet.

29. The method according to claim 26, further comprising the step of forming a static display medium in said first area and forming a dynamic display medium in said second area such that the static display medium and the dynamic display medium are substantially flush with one of the first main surface and the second main surface of the sheet.

30. The method according to claim 29, wherein the static display medium and the dynamic display medium share at least one common element including one of a conductive ink, a black matrix and a color filter.

31. The method according to claim 29, wherein each of the static display medium and the dynamic display medium is integrated in the sheet and forms a portion of the sheet.

32. A method of distributing information comprising the steps of:
providing a display medium a static display portion having statically displaying information in a first area and a dynamic display portion dynamically displaying information in a second area;
removing said dynamic display portion from said display medium;
updating information in said dynamic display portion; and
attaching said dynamic display portion to another display medium including different statically displayed information.
